(19) United States
(12) Patent Application Publication
(10) Pub. No.: US 2008/0117944 A1
(43) Pub. Date: May 22, 2008

(54) Diode laser ramping power supply

(75) Inventors: David Clifford Dawson, Brush Prairie, WA (US); David R. Balsley, Portland, OR (US)

Correspondence Address: Patent Law Office Of David G. Beck, P.O. Box 1146, Mill Valley, CA, 94942, US

(73) Assignee: nLight Photonics Corporation, Vancouver, WA (US)

(21) Appl. No.: 11/601,555

(22) Filed: Nov. 16, 2006

(51) Int. Cl. H01S 3/00

(52) U.S. Cl. 372/38.04; 372/38.07

(57) ABSTRACT

Method and apparatus are provided that limit the current ramp rate applied to a laser bar or a single emitter laser diode to a predetermined value of 150 milliamps per millisecond or less. In addition to the laser diode and its power supply, the apparatus includes a power supply control circuit that performs the function of limiting the power supply ramp rate. The power supply control circuit can be separate from, or integrated within, the power supply.

### FIELD OF THE INVENTION

The present invention relates generally to diode laser power supplies and, more particularly, to a method and apparatus for limiting damage to a diode laser during power cycling.

### BACKGROUND OF THE INVENTION

High power diode lasers, typically utilizing bar and stacked array configurations, are capable of producing in excess of hundreds of watts. In order to achieve these power levels, high drive currents are required. Unfortunately, as a result of these drive currents, a typical diode laser bar generates large amounts of heat which can lead to catastrophic failure of individual emitters or an entire laser bar. Catastrophic failure of a laser bar can, in turn, damage or destroy other system components that are in proximity to the defective laser such as optical elements, electrical components and cooling systems.

A standard laser bar power supply goes from zero output power to full power within approximately 20 milliseconds. As a result, the laser bar undergoes a rapid increase in temperature as it switches between the off and on states. Depending upon the thermal and mechanical properties of the solder used to bond the laser bar to the cooling block and the thermal properties of the cooling block, or depending upon the thermal and mechanical properties of the solder used to bond the laser bar to the submount, the thermal properties of the submount, the thermal and mechanical properties of the solder used to bond the submount to the cooling block, and the thermal properties of the cooling block, the rapid increase in temperature experienced by the laser bar may be sufficient to damage the laser bar or a portion of the laser bar (i.e., a portion of the bar's emitters). Typical damage includes both the development of cracks within the laser bar as well as laser bar delamination.

In order to overcome the problems associated with the rapid thermal cycling of laser bars, considerable effort has been expended on improving the thermal and mechanical coupling of the laser bar to the heat sink. In conventional laser bar systems, the laser bar is attached directly to the heat sink, the heat sink often being made of copper. In such systems a soft solder such as indium solder is typically used to attach the laser bar to the heat sink, a soft solder being preferred as it is capable of absorbing some of the severe CTE mismatch between the copper heat sink and the laser bar. Even with a soft solder, however, the stresses resulting from thermal cycling will often lead to cracks within the laser bar as well as delamination of the laser bar from the solder and/or heat sink. To further reduce the stresses imparted during thermal cycling, a heat sink can be selected with a CTE that closely matches that of the laser bar. Exemplary heat sink materials include copper tungsten, aluminum nitride and diamond containing a metal matrix composite. Unfortunately the thermal conductivity of such materials is typically inferior to that of copper or the materials exhibit a surface roughness that is non-conducive to forming diode bar bonds. To address the issue of limited thermal conductivity, in one approach a relatively thin substrate is fabricated from these materials, the substrate being used as a laser bar submount. The submount is then soldered to the heat sink. This architecture has the advantage of coupling the laser bar to a substrate with a similar CTE which is, in turn, coupled to a thermally efficient heat sink. This approach still, however, stresses the laser bar due, in part, to the relatively inelastic properties of the solder used to couple the laser bar to the substrate. Furthermore the inclusion of the submount and a second layer of solder results in an inefficient thermal path.

Although the prior art discloses a variety of techniques to help overcome the catastrophic effects of laser bar thermal cycling, to date these techniques have proved inadequate. Accordingly a new approach is required to alleviate these effects. The present invention provides such a system and method.

### SUMMARY OF THE INVENTION

The present invention provides a method and apparatus for limiting the ramp rate of the current applied to a laser bar to a predetermined value. Preferably the predetermined value is 150 milliamps per millisecond or less. In addition to the diode laser bar and its power supply, the system includes a power supply control circuit that performs the function of limiting the power supply ramp rate. The power supply control circuit can be separate from, or integrated within, the power supply.

In an alternate embodiment, the present invention provides a method and apparatus for limiting the ramp rate of the current applied to a single emitter laser diode to a predetermined value. Preferably the predetermined value is 150 milliamps per millisecond or less. In addition to the single emitter laser diode and its power supply, the system includes a power supply control circuit that performs the function of limiting the power supply ramp rate. The power supply control circuit can be separate from, or integrated within, the power supply.

A further understanding of the nature and advantages of the present invention may be realized by reference to the remaining portions of the specification and the drawings.

### BRIEF DESCRIPTION OF THE DRAWINGS

FIG. 1 is a block diagram illustrating the invention;

FIG. 2 is a block diagram similar to that shown in FIG. 1, except that the control circuit is integrated within the power supply; and

FIG. 3 is an example of a preferred ramp rate versus a conventional ramp rate; and

FIG. 4 is an example of a non-preferred stepped ramp.

### DESCRIPTION OF THE SPECIFIC EMBODIMENTS

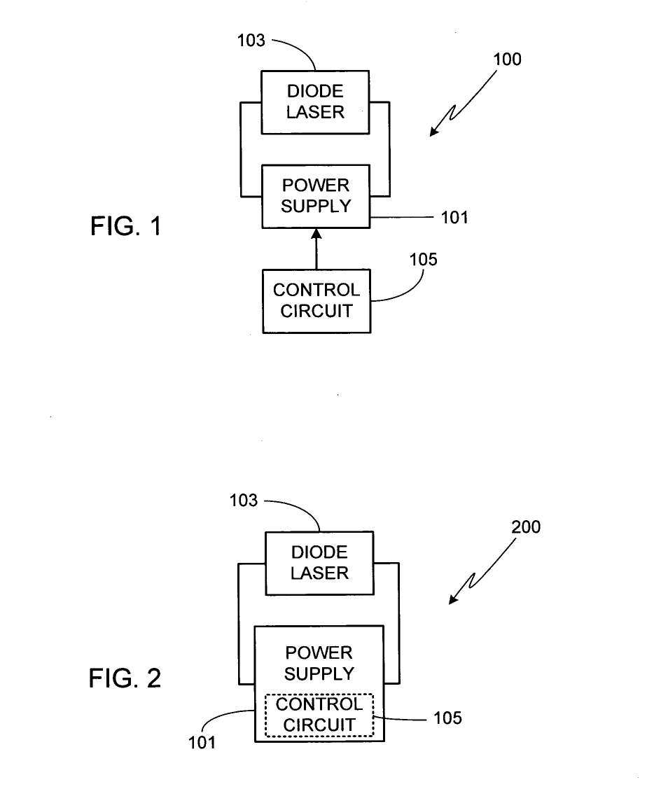

FIG. 1 is a block diagram of a laser bar power supply system 100 in accordance with the present invention. As shown, a power supply 101 is coupled to at least one laser diode 103, power supply 101 designed to supply the required electrical power to laser bar 103. Preferably the maximum output of power supply 101 applied to laser diode 103 is variable to accommodate the operating characteristics of a variety of laser types as well as variations within a specific type of laser diode that may be due, for example, to the operating temperature, age, or other variable associated with a particular laser diode. Laser diode 103 can either be a laser bar or a single emitter laser diode.

A control circuit 105 controls the rate that power supply 101 goes from zero output to full output power. It will be understood that full output power refers to the predetermined maximum output power (e.g., current) that is to be applied to laser diode 103, not to the maximum available output power of supply 101. Control circuit 105 can either be separate from power supply 101 as shown in system 100, or integrated within power supply 101 as shown in system 200 of FIG. 2.

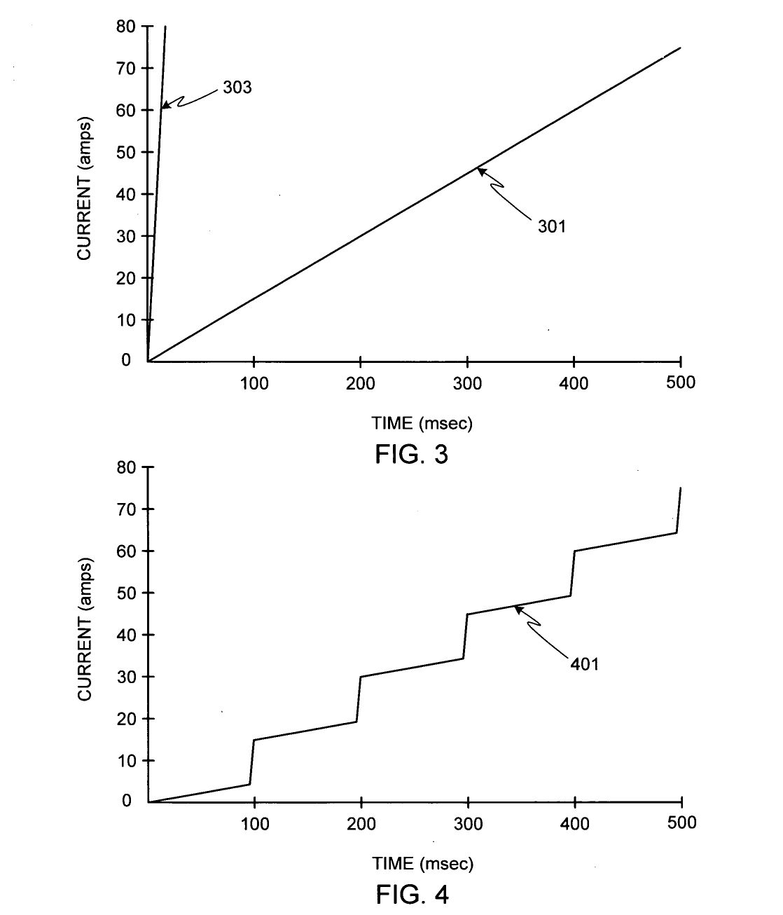

In accordance with the invention, each time that power supply 101 delivers power to laser diode 103, control circuit 105 insures that the ramp rate of supply 101 is sufficiently low to minimize damage to laser diode 103. The inventors have found that a rate of 150 milliamps per millisecond or less is preferred. This ramp rate, shown as line 301 in FIG. 3, is in marked contrast to the conventional rate of approximately 5 amps per millisecond (i.e., line 303). As a consequence of the ramp rate of the invention, achieving a bias current of 75 amps would require at least 500 milliseconds. In addition to utilizing a relatively slow ramp rate, the inventors have found that a continuous ramp (e.g., ramp 301 of FIG. 3) is preferred over a non-continuous ramp (e.g., stepped ramp 401 of FIG. 4).

The inventors have found that by significantly slowing down the ramp rate, the laser diode undergoes a much smaller temperature per time gradient than in a conventionally powered laser bar, thus minimizing strain within the laser diode since the generated heat can be more efficiently removed. As a result of not encountering large, near instantaneous temperature changes, laser diode degradation and failure due to power, and thus thermal, cycling is greatly reduced.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. A laser power supply system comprising:
at least one diode laser bar;
a power supply electrically coupled to said at least one diode laser bar; and
a power supply control circuit electrically coupled to said power supply, wherein said power supply control circuit limits the ramp rate of said power supply to 150 milliamps per millisecond or less.

2. The laser power supply system of claim 1, wherein said power supply control circuit is integrated within said power supply.

3. The laser power supply system of claim 1, wherein said ramp rate defines a rate of current increase between zero applied current and a predetermined maximum applied current.

4. The laser power supply system of claim 3, wherein said power supply is capable of multiple values for said predetermined maximum applied current.

5. A method of supplying electrical power to a laser diode, said method comprising the steps of initiating a power pulse to said laser diode and controlling a ramp rate corresponding to said power pulse to a value of 150 milliamps per millisecond or less.

6. A laser power supply system comprising:
at least one single emitter laser diode;
a power supply electrically coupled to said at least one single emitter laser diode; and
a power supply control circuit electrically coupled to said power supply, wherein said power supply control circuit limits the ramp rate of said power supply to 150 milliamps per millisecond or less.

7. The laser power supply system of claim 6, wherein said power supply control circuit is integrated within said power supply.

8. The laser power supply system of claim 6, wherein said ramp rate defines a rate of current increase between zero applied current and a predetermined maximum applied current.

9. The laser power supply system of claim 8, wherein said power supply is capable of multiple values for said predetermined maximum applied current.
